(19) United States
(12) Patent Application Publication
(10) Pub. No.: US 2024/0429410 A1
(43) Pub. Date: Dec. 26, 2024

(54) RECIRCULATION BLOWER

(71) Applicant: BorgWarner Inc., Auburn Hills, MI (US)

(72) Inventor: Sascha Weiske, Weilerbach (DE)

(73) Assignee: BorgWarner Inc., Auburn Hills, MI (US)

(21) Appl. No.: 18/224,181

(22) Filed: Jul. 20, 2023

(30) Foreign Application Priority Data
Jun. 20, 2023 (DE) 102023116112.1

(51) Int. Cl. H01M 8/04089; H01M 8/04082; H01M 8/04111; H01M 8/04858

(52) U.S. Cl. CPC H01M 8/04097; H01M 8/04111; H01M 8/04201; H01M 8/04947

(57) ABSTRACT

A recirculation blower (17) for a return arrangement for a gas, including hydrogen gas in a fuel-cell system, includes a blower (23) and a turbine (31). The blower (23) is configured to be driven by a turbine and to transport a return stream. The turbine (31) is configured to drive the blower (23) and to be driven by a hydrogen stream.

### CROSS-REFERENCE TO RELATED APPLICATIONS

This application claims priority pursuant to 35 U.S.C. 119 (a) to German Patent Application No. 102023116112.1 filed Jun. 20, 2023, which application is incorporated herein by reference in its entirety.

### BACKGROUND

The invention relates to a recirculation blower for a return arrangement for a gas comprising hydrogen gas in a fuel-cell system.

A fuel-cell system may be provided in a vehicle, for example an automobile, a train, an aircraft or a ship. Electrical energy is generated in the fuel-cell system, for example using hydrogen, for the propulsion of the vehicle.

Aside from a fuel-cell unit to which gaseous hydrogen is supplied, the fuel-cell system may have a return arrangement for returning unconsumed hydrogen gas to the entry of the fuel-cell unit. A recirculation blower is provided in the return arrangement in order for the unconsumed hydrogen gas to be returned to the entry. In this way, reduced fuel usage is achieved. The recirculation primarily improves the degree of fuel utilization and thus the efficiency.

Conventional recirculation blowers are driven electrically or mechanically. Conventional approaches according to the ejector principle manage without external supply of energy. The recirculation blower may be in the form of an electrically operated compressor, for example radial compressor. Use is also made of side-channel compressors and rotary-piston blowers, so-called Roots blowers, with a relatively low target pressure ratio.

### SUMMARY

It is the object to provide an alternative recirculation blower.

The object is achieved by a recirculation blower for a return arrangement for a gas comprising hydrogen gas in a fuel-cell system that has the features of claim 1.

The recirculation blower comprises a blower which is able to be driven by a turbine and which is configured to transport a return stream, and a turbine which is configured to drive the blower and which is able to be driven by a hydrogen stream.

A recirculation system in a fuel-cell system provides that the recirculation blower is coupled to a hydrogen reservoir.

The recirculation blower serves for returning a gas comprising hydrogen gas. The term gas comprises both hydrogen gas and a gas mixture containing hydrogen gas. Hydrogen gas is advantageously the main component of the gas mixture. The recirculation blower increases the efficiency and service life of fuel-cell systems for fuel-cell electric vehicles, for example automobiles, trains, aircraft and ships. The proposed approach aims to reduce the current demand for the recirculation blower to a minimum in order to save on fuel, that is to say hydrogen, and thus to increase the range of the vehicle.

Forming the basis of the recirculation blower is a turbine-driven blower, similar to a turbocharger compressor, wherein, for its part, the turbine is flowed through and driven by hydrogen. The recirculation blower uses the expanding hydrogen from the hydrogen reservoir and the pressure potential of the hydrogen reservoir for driving the turbine, which then drives the blower.

The hydrogen-turbine-based approach for the recirculation blower has only a low current demand, since current is at most still required for idle ventilation of the fuel-cell unit, and saves significantly on electrical energy, which can be used for increasing the range of the vehicle. Moreover, the turbine drive offers additional cost-saving potential since no elaborate power electronics, coolants, air bearings or measures for counteracting penetration of hydrogen are necessary.

The recirculation blower transports hydrogen that has not been consumed during the reaction in a fuel-cell unit back into the fuel-cell unit of the fuel-cell system, which reduces the hydrogen usage and the aging of the fuel-cell unit. The recirculation blower advantageously also acts as a compressor, in order to maintain the flow direction of the hydrogen to the entry of the fuel cell. The blower, as compressor, transports this unconsumed hydrogen as a return stream back to the entry of the fuel-cell unit. The driving of the blower is realized by way of a hydrogen stream which, as fuel for a fuel-cell unit, is guided from a hydrogen reservoir into the fuel-cell unit through the turbine of the recirculation blower. The recirculation system of the fuel-cell system thus uses the relatively high pressure level in the hydrogen reservoir for improved efficiency of the system.

In one embodiment, the recirculation blower comprises a blower impeller in the blower for transporting the return stream and a turbine impeller in the turbine. The blower impeller and the turbine impeller are coupled to one another in such a way that rotation of the turbine impeller drives the blower impeller in that the rotation of the turbine impeller is transmitted to the blower impeller. The turbine impeller is able to be driven by the hydrogen stream.

The blower impeller is turbine-driven, wherein the hydrogen from the hydrogen reservoir drives the turbine impeller before being guided into the fuel-cell unit. The hydrogen flowing into the fuel-cell unit is, on its way thereto, used for driving the recirculation blower.

The return stream, comprising hydrogen to be returned, and the hydrogen stream, comprising the hydrogen to be supplied to the fuel-cell unit from the hydrogen reservoir, flow through the recirculation blower in a spatially separated manner.

In one embodiment, the recirculation blower comprises a turbine inlet in the turbine, through which hydrogen is able to be guided from the hydrogen reservoir to the turbine impeller as a hydrogen stream such that the hydrogen stream drives the turbine impeller and the latter rotates. The hydrogen stream exits the turbine through a turbine outlet and flows into the fuel-cell unit. The return stream flows from a blower inlet to a blower outlet through the blower.

The blower may be driven in a purely turbine-driven manner. In such an embodiment, additional electrical driving of the blower is not provided, and so problems due to the penetration of hydrogen with respect to electrical or electromagnetic components are avoided. In this turbine-driven blower, costs and outlay are relatively low.

In one embodiment, the blower may additionally be able to be driven electrically, so that, as an alternative to the turbine drive, it can be driven electrically, or the turbine drive is assisted electrically. With a combination of turbine drive and electric drive, the power requirements for the electric drive are significantly lower than would be the case with a conventional purely electric drive. The turbine drive saves significantly on electrical energy during the operation of the fuel-cell system. An electric motor provided for the electric drive is to be scaled off against penetration of hydrogen.

Advantageously, a power of the turbine drive is able to be regulated in order, in this way, to set the compressor power of the blower too. Such regulation may be realized in that the hydrogen stream from the reservoir driving the turbine impeller is throttled. This may be realized for example by a valve which is connected upstream of the turbine and which throttles the hydrogen stream as a pressure-reduction valve. Alternatively or additionally, the regulation may be realized in that only a part of the hydrogen stream from the reservoir flows through the turbine, while the other part is guided past the turbine. For this purpose, a valve, in particular a bypass valve, may be provided. In one embodiment, the bypass valve may be arranged close to the wastegate of the charger. The valves may be an integral constituent part of the recirculation blower, or be provided as separate components in the recirculation system, in order to regulate the turbine. In the case of an electrically assisted turbine drive, the turbine drive may also be regulated by way of regulation of the electric drive by means of electrical energization. A further approach for regulating the turbine drive and in the process using the expansion gradient from the reservoir provides for removal of a part of the electrical energy through braking of the turbine.

In one embodiment, the blower impeller and the turbine impeller are comprised by a rotor. The rotor comprises the rotating components of the recirculation blower. Advantageously, the rotor is able to be driven electrically, so that the blower impeller does not necessarily have to be driven by the turbine impeller. In one embodiment, the turbine-driven rotation of the rotor may be assisted electrically. In one embodiment, an electric motor is coupled to the rotor so as to drive the rotor or to assist with the rotation thereof. The electric motor can be controlled in such a way as to allow the power of the blower to be influenced as a result.

In one embodiment, the rotor comprises a shaft which is connected to the turbine impeller and to the blower impeller. The turbine impeller and the blower impeller are arranged on the end regions of the shaft. The electric motor is arranged between the blower impeller and the turbine impeller. The shaft is able to be driven by the electric motor, or the electric motor is able to assist with the rotation of the shaft. This arrangement of the electric motor is associated with a compact design.

Alternatively, the electric motor is arranged on a side of the blower impeller that faces away from the turbine impeller, or the electric motor is arranged on a side of the turbine impeller that faces away from the blower impeller. In these arrangements, the blower impeller and the turbine impeller may be positioned closer to one another. This may be realized to such an extent that, in one embodiment, the turbine impeller and the blower impeller are arranged in a back-to-back arrangement and are designed as one component.

In one embodiment, at least a part of the hydrogen stream is able to be guided past the turbine impeller, so that the power of the blower can be influenced. This type of regulation of the turbine may be realized by a bypass valve, also referred to as “wastegate”, or a comparable power-regulating mechanism. The bypass valve guides at least a part of the hydrogen stream past the turbine impeller when it is open. In the closed state, the hydrogen stream flows via the turbine impeller.

Electric motor and bypass valve make it possible for the power of the blower to be controlled and to be adapted to operating requirements.

The recirculation blower is used in a recirculation system of a fuel-cell system. The recirculation blower is coupled to the hydrogen reservoir from which the hydrogen for driving the turbine impeller is fed. The turbine inlet of the recirculation blower is coupled to the hydrogen reservoir in such a way that the hydrogen stream drives the turbine impeller.

Advantageously, the recirculation blower is coupled between the hydrogen reservoir and a fuel-cell unit such that the hydrogen stream can drive the recirculation blower before flowing into the fuel-cell unit. The coupling may be realized by means of further components, for example by way of a valve. It is also the case that the return stream comprising the unconsumed hydrogen flows, transported by the blower, back into the fuel-cell unit. For this purpose, the blower of the recirculation blower is coupled between exit and entry of the fuel-cell unit.

The above-described recirculation blower may be based on a conventional blower design which has been adapted with regard to its use for gas streams composed of hydrogen, so that costs and outlay are reasonable even with regard to the power electronics and the electric motor.

### BRIEF DESCRIPTION OF THE DRAWINGS

A number of exemplary embodiments will be discussed in more detail below on the basis of the drawing, in which:

FIG. 1 schematically shows an exemplary embodiment of a conventional fuel-cell system;

FIG. 2 schematically shows an exemplary embodiment of a fuel-cell system with a recirculation blower, with a turbine drive;

FIG. 3 schematically shows a further exemplary embodiment of a fuel-cell system with a recirculation blower, with an electrically assisted turbine drive;

FIG. 4 schematically shows an exemplary embodiment of a rotor with an electric motor;

FIG. 5 schematically shows a further exemplary embodiment of a rotor with an electric motor;

FIG. 6 schematically shows yet a further exemplary embodiment of a rotor with an electric motor;

FIG. 7 schematically shows the exemplary embodiment from FIG. 5 with bearing points; and

FIG. 8 schematically shows an exemplary embodiment of a blower impeller and a turbine impeller in a back-to-back arrangement.

In the figures, components that are identical or have the same effect are provided with the same reference signs.

### DETAILED DESCRIPTION

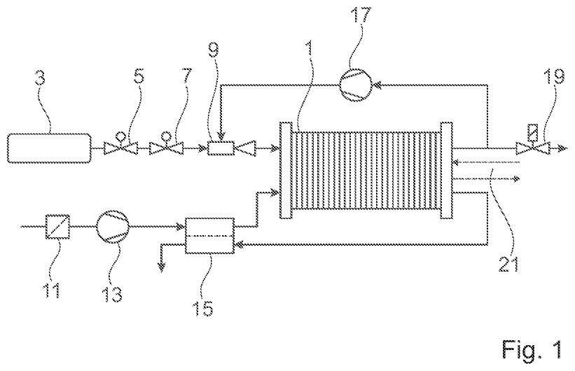

FIG. 1 schematically shows an exemplary embodiment of a conventional fuel-cell system with a fuel-cell unit 1 which comprises a stack with multiple fuel cells. The fuel cells each have an anode and a cathode and an interposed rotor membrane. A fuel, in this exemplary embodiment gaseous hydrogen, is supplied at the anode side. The supply is performed from a hydrogen reservoir 3, which is in the form of a tank, via a pressure reducer 5 and via a pressure-regulating valve 7 connected downstream of the pressure reducer 5. Hydrogen from the pressure-regulating valve 7 and hydrogen returned from the fuel-cell unit 1 are supplied at the anode side via an ejector 9 of the fuel-cell unit 1. An oxidant, commonly air, is supplied at the cathode side. The supply is performed via a filter 11 and an air compressor 13. The compressed air passes through an air humidifier 15, in order to improve efficiency, and is supplied to the fuel-cell unit 1 at the cathode side.

The fuel and the oxidant react in the interior of the fuel cells and release energy, with water simultaneously being produced. Hydrogen that flows from the hydrogen reservoir 3 into the anode side is however normally not converted entirely into water. Nitrogen and water which are formed during the reaction in the anode, and which would progressively decrease efficiency, are discharged from the fuel-cell unit 1 in order to create space for hydrogen. In this way, an efficient reaction is made possible and the sensitive membrane in the hydrogen cells is not damaged, so that the fuel-cell system 1 functions effectively even at cold temperatures and has a long service life. Owing to the aforementioned points, provision is made of a return circuit having a recirculation blower 17 in the return arrangement for the gas comprising hydrogen gas, and having a discharge valve 19 at the anode. A recirculation blower 17 increases the efficiency and the robustness of the system, in particular with regard to protection at cold temperatures, and the service life. Nevertheless, the provision of it is optional. At the anode, provision is made of a separate return circuit having the recirculation blower 17, which returns the unconsumed hydrogen and blows the nitrogen and the excess water out of the cell. The return circuit, on the one hand, feeds the unconsumed hydrogen back into the anode entry and, on the other hand, discharges the nitrogen and the excess water through the discharge valve 19. The water is guided to the air humidifier 15 for the purpose of humidifying the entry air.

Cooling connections 21 of the fuel-cell unit 1 are connected to a cooling system for the purpose of cooling the fuel-cell unit 1.

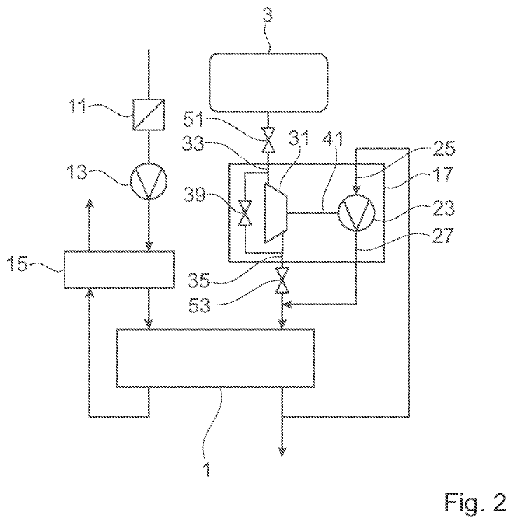

FIG. 2 schematically shows an exemplary embodiment of a fuel-cell system with a recirculation blower, with a turbine drive. The description concentrates on differences in relation to the preceding exemplary embodiment.

In this exemplary embodiment too, the supply of air is performed via a filter 11, an air compressor 13 and an air humidifier 15 which is coupled to an exit of the fuel-cell unit 1.

The recirculation blower 17 is coupled into a return branch for the purpose of returning hydrogen accumulating at the exit side of the fuel-cell unit 1 to the entry of the fuel cell. In this exemplary embodiment, the recirculation blower 17 is coupled not only between exit and entry of the fuel-cell unit 1, but additionally also between the hydrogen reservoir 3 and the fuel-cell unit 1.

The hydrogen reservoir 3 provides the fuel, specifically hydrogen, for the fuel-cell unit 1. A pressure-reduction valve 51 is provided between the hydrogen reservoir 3 and the recirculation blower 17. A pressure-control valve 53 is provided between the recirculation blower 17 and the fuel-cell unit 1. The valves 51, 53 regulate the pressure of the hydrogen stream flowing into the recirculation blower 17 and flowing out of the latter.

The recirculation blower 17 comprises a blower 23 with a blower inlet 25, with a blower outlet 27, and with a blower impeller 29 which transports a return stream comprising unconsumed hydrogen through the blower 23. The exit of the fuel-cell unit 1 is coupled to the blower inlet 25. The entry of the fuel-cell unit 1 is coupled to the blower outlet 27. The recirculation blower 17 comprises a turbine 31 with a turbine inlet 33, with a turbine outlet 35, and with a turbine impeller 37 which is driven by a hydrogen stream fed from the hydrogen reservoir 3. The turbine inlet 33 is coupled to the pressure-reduction valve 51. The turbine outlet 35 is coupled to the pressure-control valve 53. The turbine impeller 37 and the blower impeller 29 are connected to one another by a shaft 41, so that rotation of the turbine impeller 37 is transmitted to the blower impeller 29 and drives it. The rotating components of the recirculating blower 17 are referred to as a rotor. The rotor comprises the turbine impeller 37, the blower impeller 29 and the shaft 41. The blower 23 is able to be driven by the turbine 31, which for its part is driven by the hydrogen stream. The blower 23 and the turbine 31 are arranged in a housing of the recirculation blower 17.

The turbine 31 is designed in such a way that it is possible for there to be intermittently guided at least a part of the hydrogen stream past the turbine impeller 37. For this purpose, provision is made of a bypass valve 39 which, in an open state, guides at least a part of the hydrogen stream from the turbine inlet 33 to the turbine outlet 35 past the turbine impeller 37. In this way, the performance of the recirculation blower 17 can be controlled, since the amount of hydrogen which is guided to the turbine impeller 37 is regulated by the bypass valve 39. This affects the rotational speed of the turbine impeller 37 and consequently the rotational speed and performance of the blower 23. The pressure-reduction valve 51 and the bypass valve 39 allow regulation of the hydrogen stream flowing through the turbine 31 and thus also regulation of the turbine power by means of the hydrogen stream, which affects the compressor power of the blower 23.

During operation, the hydrogen stream flowing from the hydrogen reservoir 3 to the fuel-cell unit 1 through the turbine 31 drives the turbine impeller 37. The rotation is transmitted by the shaft 41 to the blower impeller 29, which compresses the unconsumed hydrogen from the fuel-cell unit 1 through the blower 23 and transports it to the entry of the fuel-cell unit 1.

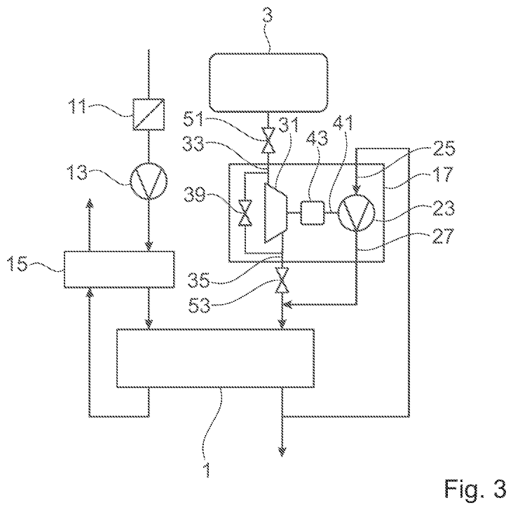

FIG. 3 schematically shows an exemplary embodiment of a fuel-cell system with a recirculation blower 17, with an electrically assisted turbine drive. In order to avoid repetitions, the description concentrates on the recirculation blower 17 and the differences thereof in relation to the above-described exemplary embodiment.

In this exemplary embodiment, the drive of the blower 23 may alternatively be realized electrically or be assisted electrically. For this purpose, provision is made of an electric motor 43 which drives the rotor with turbine impeller 37 and blower impeller 29. An electric motor 43 provided essentially for assisting with the turbine drive requires significantly less power than the electric drive of a conventional electrically driven recirculation blower. This is associated with a compact construction and lower outlay and costs.

The electric motor 43 can be controlled in such a way as to allow the power of the blower 23 to be influenced. Consequently, in addition to the bypass valve 39, further possibilities arise for influencing and for controlling the performance of the blower 23 in that, by means of the electric motor 43, the rotational speed of the shaft 41, and thus of the blower impeller 29, is regulated.

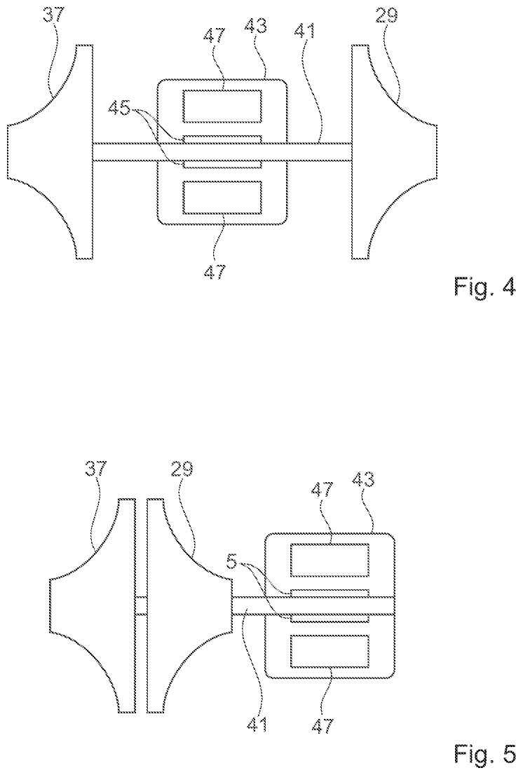

FIG. 4 schematically shows an illustration of the rotor and the electric motor 43 in an exemplary embodiment. The turbine impeller 27 and the blower impeller 29 are coupled via the shaft 41 in such a way that the rotation of the turbine impeller 37 is transmitted to the blower impeller 29. The electric motor 43 is arranged between the blower impeller 29 and the turbine impeller 37, and the electric motor 43 is coupled to the shaft 41 such that the latter is able to be driven by the electric motor 43 or the electric motor 43 is able to assist with the rotation thereof. One exemplary embodiment of the electric motor 43 comprises a magnetically active region 45 on the shaft 41, for example permanent magnets. Arranged around the magnetically active region 45 are magnetically active regions 47 of a stator, which are designed for example as coils with windings through which a current that varies over time can flow. A magnetic field varying over time that, with the permanent magnets, as magnetically active region of the rotor 43, effects rotation of the rotor is induced in a manner dependent on the current varying over time that flows through the windings. A control circuit controls the electric motor 43.

FIG. 5 schematically shows a further exemplary embodiment of a rotor with an electric motor. In this exemplary embodiment, the electric motor 43 is attached on the blower side such that it is arranged not between the turbine impeller 37 and the blower impeller 29, but adjacent to that side of the blower impeller 29 which faces away from the turbine impeller 37. This arrangement allows the blower impeller 29 and the turbine impeller 37 to be arranged so as to be moved closer together than in the previous exemplary embodiment.

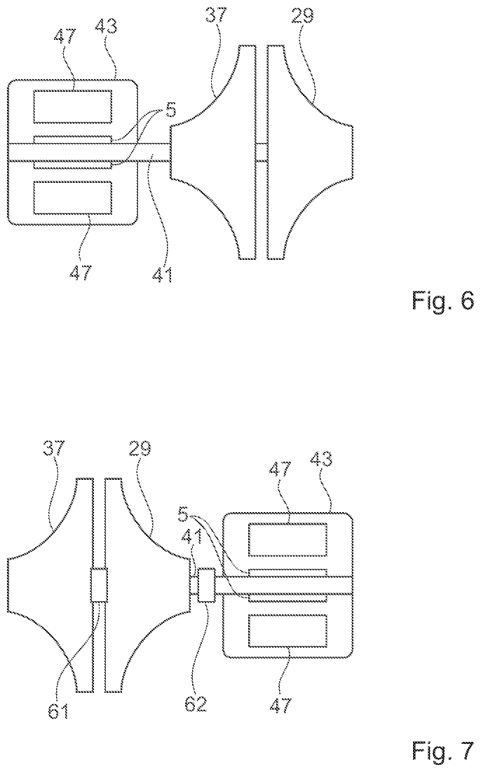

FIG. 6 schematically shows a further exemplary embodiment of a rotor with an electric motor. In this exemplary embodiment, the electric motor 43 is attached on the turbine side such that it is arranged adjacent to that side of the turbine impeller 37 which faces away from the blower impeller 29. This arrangement allows the blower impeller 29 and the turbine impeller 37 to be arranged in a closely adjacent manner.

FIG. 7 schematically shows the exemplary embodiment of the rotor with the electric motor from FIG. 5 and illustrates possible arrangements for mounting the shaft 41. The arrangement of the electric motor 43 on the blower side gives rise to various possibilities for the arrangement of the bearing point for the shaft 41. The bearing point 61 may be arranged between the blower impeller 29 and the turbine impeller 37. Alternatively, the bearing point 62 may be arranged between the blower impeller/turbine impeller set and the electric motor 43, that is to say between the blower impeller 29 and the electric motor 43. It is also conceivable for both bearing points 61, 62 to be provided.

It goes without saying that the above-described possibilities for the arrangement of the bearing points 61, 62 for the shaft 41 also exist if the electric motor 43 is arranged on the turbine side as illustrated in FIG. 6. The bearing point 61 may be arranged between the blower impeller 29 and the turbine impeller 37 or between the blower impeller/turbine impeller set and the electric motor 43, that is to say between the turbine impeller 37 and the electric motor 43.

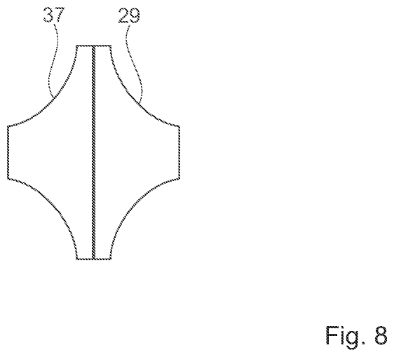

FIG. 8 schematically illustrates the embodiment of the blower impeller/turbine impeller set in the form of a back-to-back arrangement of blower impeller 29 and turbine impeller 37, which are arranged so as to be immediately adjacent at their back sides. There is no need for the connecting function of the shaft 41 between the impellers 29, 37 because, in this exemplary embodiment, the blower impeller 29 and the turbine impeller 37 are designed as a component. Alternatively, mutual contact is also possible for the backs of separately designed turbine impeller 37 and blower impeller 29 in the back-to-back arrangement.

The features specified above and in the claims and shown in the figures can be advantageously implemented both individually and in various combinations. The invention is not restricted to the exemplary embodiments described, but may be modified in various ways within the scope of the abilities of a person skilled in the art.

### REFERENCE SIGNS

1 Fuel-cell unit
3 Hydrogen reservoir
5 Pressure reducer
7 Pressure-regulating valve
9 Ejector
11 Filter
13 Air compressor
15 Air humidifier
17 Recirculation blower
19 Discharge valve
21 Cooling connection
23 Blower
25 Blower inlet
27 Blower outlet
29 Blower impeller
31 Turbine
33 Turbine inlet
35 Turbine outlet
37 Turbine impeller
39 Bypass valve
41 Shaft
43 Electric motor
45 Magnetically active region
47 Magnetically active region
51 Pressure-reduction valve
53 Pressure-control valve
61, 62 Bearing point

What is claimed is:

1. A recirculation blower for a return arrangement for a gas comprising hydrogen gas in a fuel-cell system, the recirculation blower comprising:
a blower configured to be driven by a turbine and configured to transport a return stream, and
a turbine configured to drive the blower and configured to be driven by a hydrogen stream.

2. The recirculation blower as claimed in claim 1, further comprising a blower impeller for transporting the return stream and a turbine impeller, which are coupled to one another in such a way that rotation of the turbine impeller drives the blower impeller, wherein the turbine impeller is configured to be driven by the hydrogen stream.

3. The recirculation blower as claimed in claim 2, further comprising a turbine inlet in the turbine, through which hydrogen is able to be guided to the turbine impeller as a hydrogen stream such that the hydrogen stream drives the turbine impeller and the latter rotates.

4. The recirculation blower as claimed in claim 1, wherein the blower is configured to be driven electrically and/or the turbine is configured to be assisted electrically.

5. The recirculation blower as claimed in claim 1, wherein a power of the turbine is configured to be regulated.

6. The recirculation blower as claimed in claim 4, further comprising a blower impeller for transporting the return stream and a turbine impeller, which are coupled to one another in such a way that rotation of the turbine impeller drives the blower impeller, wherein the turbine impeller is configured to be driven by the hydrogen stream, and wherein the blower impeller and the turbine impeller are comprised by a rotor, and an electric motor is coupled to the rotor for driving the rotor and/or for assisting with the rotation thereof.

7. The recirculation blower as claimed in claim 6, wherein the rotor comprises a shaft coupled to the turbine impeller and to the blower impeller, and wherein the shaft is configured to be driven by an electric motor or the electric motor is configured to assist with the rotation of the shaft.

8. The recirculation blower as claimed in claim 7, wherein the electric motor is arranged between the blower impeller and the turbine impeller, or wherein the electric motor is arranged on a side of the blower impeller that faces away from the turbine impeller, or wherein the electric motor is arranged on a side of the turbine impeller that faces away from the blower impeller.

9. The recirculation blower as claimed in claim 8, wherein the turbine impeller and the blower impeller are arranged in a back-to-back arrangement and are configured as one component.

10. The recirculation blower as claimed in claim 2, in which at least a part of the hydrogen stream is able to be guided past the turbine impeller.

11. The recirculation blower as claimed in claim 1, in which the hydrogen stream is able to be throttled on an entry side of the turbine.

12. The recirculation blower as claimed in claim 2, wherein the blower is configured to be driven electrically and/or the turbine is configured to be assisted electrically.

13. The recirculation blower as claimed in claim 3, wherein the blower is configured to be driven electrically and/or the turbine is configured to be assisted electrically.

14. The recirculation blower as claimed in one of claim 2, further comprising a bypass valve for guiding at least a part of the hydrogen steam past the turbine impeller.

15. The recirculation blower as claimed in claim 1, further comprising a pressure-reduction valve for throttling the hydrogen stream on an entry side of the turbine.

16. A recirculation system in a fuel-cell system, the recirculation system having a recirculation blower as claimed in claim 1 which is coupled to a hydrogen reservoir.

17. The recirculation system as claimed in claim 16, wherein the recirculation blower further comprises a turbine inlet in the turbine, through which hydrogen is able to be guided to the turbine impeller as a hydrogen stream such that the hydrogen stream drives the turbine impeller and the latter rotates, and wherein the turbine inlet is coupled to the hydrogen reservoir such that the hydrogen stream is fed from the hydrogen reservoir.

18. The recirculation system as claimed in claim 16, wherein the recirculation blower is coupled between the hydrogen reservoir and a fuel-cell unit.

19. The recirculation system as claimed in claim 18, wherein the recirculation blower is coupled between an exit and entry of the fuel-cell unit.
